(19) United States
(12) Patent Application Publication
(10) Pub. No.: US 2010/0157959 A1
(43) Pub. Date: Jun. 24, 2010

(54) METHOD AND DEVICE FOR ASSIGNING TRAFFIC CHANNELS IN A WIRELESS COMMUNICATION SYSTEM

(75) Inventors: BRADLEY M. HIBEN, GLEN ELLYN, IL (US); KEVIN G. DOBERSTEIN, ELMHURST, IL (US); CHRISTOPHER H. WILSON, LAKE ZURICH, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 12/340,654

(22) Filed: Dec. 20, 2008

(51) Int. Cl. H04B 7/212

(52) U.S. Cl. 370/337

(57) ABSTRACT

A device uses a method for assigning a traffic channel in a wireless communication system. The method includes: receiving on a control channel a first message that includes a request for a traffic channel having a traffic channel structure; determining a delay in arrival of the first message; comparing the delay in arrival to a threshold value for the traffic channel structure; and when the delay in arrival exceeds the threshold value, assigning an available traffic channel in response to the request, wherein the traffic channel has a delay tolerance that exceeds the delay in arrival.

### FIELD OF THE DISCLOSURE

The present disclosure relates generally to communication systems and more particularly for assigning a traffic channel in a wireless communication system.

### BACKGROUND

Wireless communication systems are known to include a plurality of communication units that transmit and receive information over communication resources via a plurality of base stations, or repeaters. Some wireless communication systems, such as trunked systems, also include a central controller, or communication resource allocator, that allocates the communication resources to the communication units. The communication units may be mobile radios, portable radios, or radiotelephones; whereas, the communication resources may be frequency carriers, pairs of frequency carriers, time slots, pairs of time slots, or combinations of time slots and frequency carriers, depending on the multiplexing scheme incorporated in the wireless communication system.

In a time division multiple access (TDMA) communication system, the communication resources comprise both RF channels and time slots. The controller assigns a time slot on an RF channel to a group of communication units to enable the group of communication units to exchange information. Accordingly, in a TDMA communication system, the communication units should transmit the media within a pre-defined time period, referred to herein as a “TDMA slot”, which includes both actual modulation burst length including ramp up and ramp down and a guard time to allow for propagation delays in the RF transmission. When the propagation delays exceed the defined guard time, the transmission of a certain communication unit may encroach into the subsequent adjacent TDMA slot, and interfere with the transmission there. This propagation delay in the RF transmission will vary based on the distance between the communicating unit and the base station it is using.

Accordingly, there is a need for a method and apparatus for assigning traffic channels to units with varying propagation delays in a wireless communication system.

### BRIEF DESCRIPTION OF THE FIGURES

The accompanying figures, where like reference numerals refer to identical or functionally similar elements throughout the separate views, together with the detailed description below, are incorporated in and from part of the specification, and serve to further illustrate embodiments of concepts that include the claimed invention, and explain various principles and advantages of those embodiments.

FIG. 1 illustrates a diagram of a wireless communication system in accordance with some embodiments.

FIG. 2 illustrates a flow diagram of method for assigning a traffic channel in accordance with some embodiments.

FIG. 3 illustrates slots in a control channel in accordance with some embodiments.

FIG. 4 illustrates a two-slot TDMA traffic channel in accordance with some embodiments.

FIG. 5 illustrates the operation of delayed transmissions in a two-slot TDMA traffic channel in accordance with some embodiments.

FIG. 6 illustrates a four-slot TDMA traffic channel in accordance with some embodiments.

FIG. 7 illustrates a FDMA traffic channel in accordance with some embodiments.

FIG. 8 illustrates a four-slot TDMA traffic channel with delayed transmissions in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention. In addition, the description and drawings do not necessarily require the order illustrated. It will be further appreciated that certain actions and/or steps may be described or depicted in a particular order of occurrence while those skilled in the art will understand that such specificity with respect to sequence is not actually required.

Apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

### DETAILED DESCRIPTION

Generally speaking, pursuant to the various embodiments, a method for assigning a traffic channel in a wireless communication system is described. The method can be performed in a controller in a wireless communication system. The method comprises receiving, on a control channel, a first message that includes a request for a traffic channel having a traffic channel structure. Further, a delay in arrival of the first message is determined, for instance, relative to the beginning of a TDMA slot structure for the control channel. The method further includes comparing the determined delay in arrival to a threshold value for the traffic channel structure. When the determined delay in arrival exceeds the threshold value, an available traffic channel is assigned in response to the request. The assigned traffic channel has a delay tolerance that exceeds the delay in arrival of the message received on the control channel.

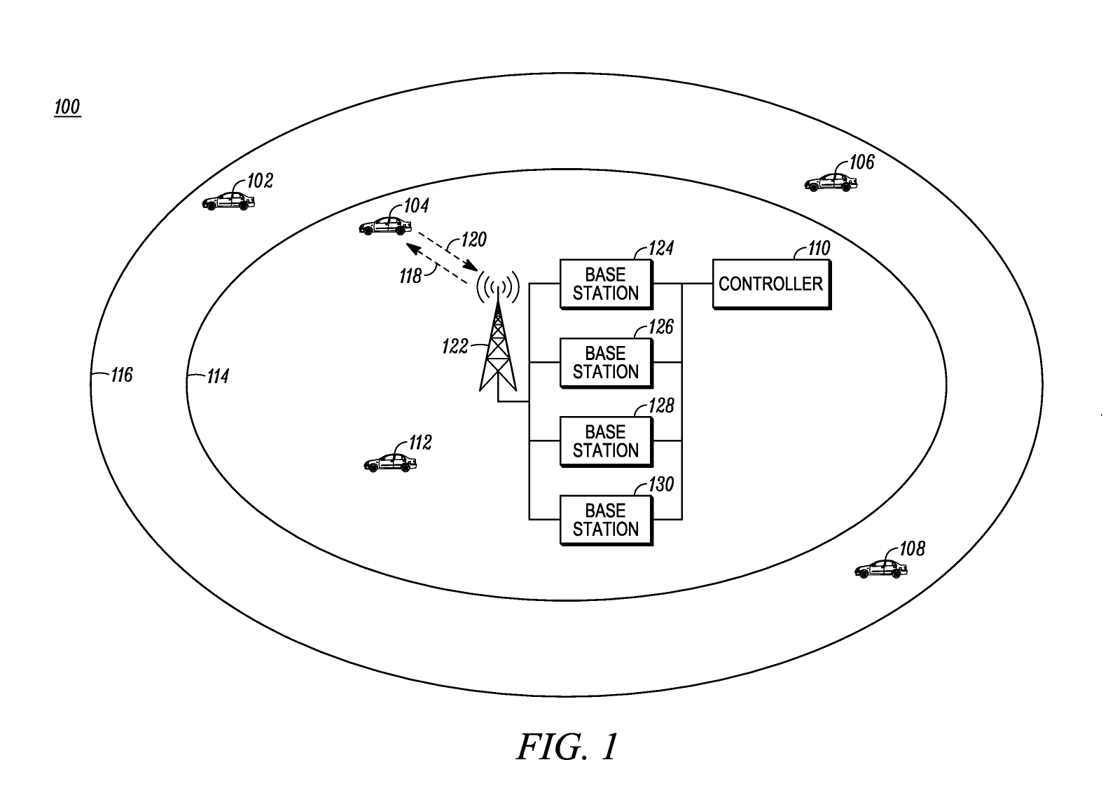

Referring now to the figures, FIG. 1 illustrates a wireless communication system 100 in accordance with some embodiments. At present, standards bodies such as TIA (Telecommunications Industry Association), OMA (Open Mobile Alliance), 3GPP (3rd Generation Partnership Project), 3GPP2 (3rd Generation Partnership Project 2), IEEE (Institute of Electrical and Electronics Engineers) 802, and WiMAX Forum are developing standards specifications for wireless communication systems. In one illustrative embodiment the teachings herein are implemented in TDMA communication systems.

Turning again to FIG. 1, wireless communication system 100 is depicted in a generalized manner. For example, the wireless communication system 100 is shown to simply include four base stations 124, 126, 128, and 130 connected to a controller (e.g., a base station controller) 110. For the purposes of this particular embodiment, base station 124 provides a control channel, base station 126 provides an FDMA voice channel, base station 128 provided a two-slot TDMA voice channel and base station 130 provides a four-slot TDMA voice channel. The wireless communication system 100 includes wireless coverage areas 114 and 116 and vehicle mounted wireless communication devices 102, 104, 106, 108, and 112 (referred to herein after as wireless communication devices).

In this particular embodiment, the wireless coverage area 114 illustrates the maximum range supported by the two-slot and four-slot TDMA traffic channels provided by base stations 128 and 130. Further, in this embodiment the wireless coverage area 116 illustrates the maximum range supported by the control channel provided by base station 124. The controller 110 provides network services to wireless communication devices 102, 104, 106, 108, 112 using wireless interfaces. The wireless interfaces are in accordance with the particular access technology supported by the controller 110 and the wireless devices. For example, all of the wireless communication devices may utilize the same technology, or they may utilize different access technologies.

Each wireless communication device includes the capability to communicate with the controller 110 through one or more wireless communication protocols such as Advanced Mobile Phone System (AMPS), Code division multiple access (CDMA), Time division multiple access (TDMA), Frequency division multiple access (FDMA), Global System for Mobile communications (GSM), Integrated Digital Enhanced Network (iDEN), General Packet Radio Service (GPRS), Enhanced Data rates for GSM Evolution (EDGE), Universal Mobile Telecommunications System (UMTS), Wideband Code Division Multiple Access (WCDMA), Code division multiple access 2000 (CDMA2000), and their variants. The wireless communication devices 102, 104, 106, 108, 112 might also use ad-hoc communication to connect directly to each other and execute applications that utilize the ad-hoc connection.

The controller, communication devices, and base stations are equipped with transceivers, memories and processing devices operatively coupled and adapted, arranged, configured and designed to carry out their functionality, including any functionality needed to implement the teachings herein. The controller and communication devices are further equipped with any other elements needed for a commercial embodiment.

As used herein, the controller 110 is a device that is a part of a fixed network infrastructure and can receive information (either control or media, e.g., data, voice (audio), video, etc.) in a signal from a communication device and transmit information in signals to one or more communication devices via a communication link, and in this illustrative embodiment, via one or more other infrastructure devices. For example, the controller may be implemented in or across one or more RAN components, such as a base transceiver station (BTS) and/or a base station controller (BSC), a Node-B and/or a radio network controller (RNC), or an HRPD AN and/or PCF, or implemented in or across one or more access network (AN) components, such as an access service network (ASN) gateway and/or ASN base station (BS), an access point (AP), a wideband base station (WBS), and/or a WLAN (wireless local area network) station, and the like.

In general, communication links (also referred to herein as channels) comprise the physical communication resources (e.g., radio frequency (RF) resources, cable lines) over which information is sent between the elements within system 100. Communication links can be wireless or wired. For example, as illustrated in FIG. 1, controller 110 communicates with the communication devices via wireless links 118 and 120 through a base station (e.g., 124) in a tower 122. The illustrated communication links are: a dashed line 118 leading from the base station 122, 124 and terminating in an arrow at the communication device 104, thereby indicating a downlink channel with transmissions flowing in the direction of the arrow; and a dashed line 120 leading from a communication device and terminating in an arrow at a base station. Although not shown, all of the communication devices within range of the control channel have access to links 118 and 120 to request traffic channels that are assigned in accordance with the teachings herein. Moreover, in this embodiment, the base stations are networked together and are connected to the based station controller via wired links.

As referred to herein, a wireless communication device includes, but is not limited to, devices commonly referred to as access terminals, mobile radios, mobile stations, subscriber units, user equipment, mobile devices, or any other device capable of operating in a wired or wireless environment. Examples of wireless communication devices include, but are not limited to, two-way radios, mobile phones, cellular phones, Personal Digital Assistants (PDAs), laptops and pagers.

Only one controller and a limited number of base stations and communication devices are shown for ease of illustration. However, system 100 can comprise any number of controllers that supports any number of base stations and communication devices, based on system requirements. Moreover, embodiments are not dependent on the applications and protocol(s) running on the devices in the system and used to facilitate communications in the system but can be used with any such applications and protocols.

Operationally in one embodiment, the controller accepts transmissions on the control channel, even from the wireless coverage area 116. The transmissions on the control channel via base station 124 and via interface 118, are done at arbitrary slot timing. The communication devices receive the signal 118 with their receiver and synchronize their transmitter timing to the slot timing on 118. When the communicating devices transmit on 120 they use the slot timing of 118 to define the slot timing on 120. Thereby, the controller 110 defines the slot timing for all of area 116. The slot timing derived at the communicating device 104 is delayed with respect to the slot timing at the controller 110 by the amount of time it takes for the signal to propagate the distance between the controller 110 and the communication device 104. This time is equal to the distance between the two entities divided by the speed of light (the delay equates to approximately 5.36 micro-seconds per mile).

The slots received at the controller 110 transmitted by communication device 104 are additionally delayed by the time it takes for the signal to propagate the distance between the communication device 104 and the controller 110. This time is equal to the distance between the two entities divided by the speed of light. The total delay seen at the controller 110 is therefore the sum of these two delays, which is equivalent to 2 times the distance between the controller 110 and the communication device 104 divided by the speed of light. The larger the distance between the controller and the communication device, the greater the delay in the slots received on path 118, 120. The delayed transmissions from wireless communication devices, such as 102, 106, and 108 that are outside the wireless coverage area 114 will interfere with transmissions in the adjacent subsequent slot if these units are assigned to TDMA voice channels.

In this situation, when transmissions from two or more wireless communication devices interfere with each other, neither of the wireless communication devices is able to effectively use their traffic channel. Therefore, there exists a need to minimize this interference on a traffic channel. The teachings herein can be used to minimize and substantially eliminate this interference on the traffic channel.

According to the embodiment described herein, whenever the controller 110 receives a request for a traffic channel from a wireless communication device on the control channel, the controller 110 determines the delay in arrival of the request on link 120. Subsequently, the controller 110 compares the delay in arrival of the request to a threshold value. Throughout the disclosure, the threshold value is considered to be equal to the guard time for a single slot of an assigned traffic channel. However, the threshold value can also be determined dynamically by the controller 110. Additionally, multiple threshold values can also be used by the controller 110. In one embodiment, each different type of voice channel may have a unique threshold value.

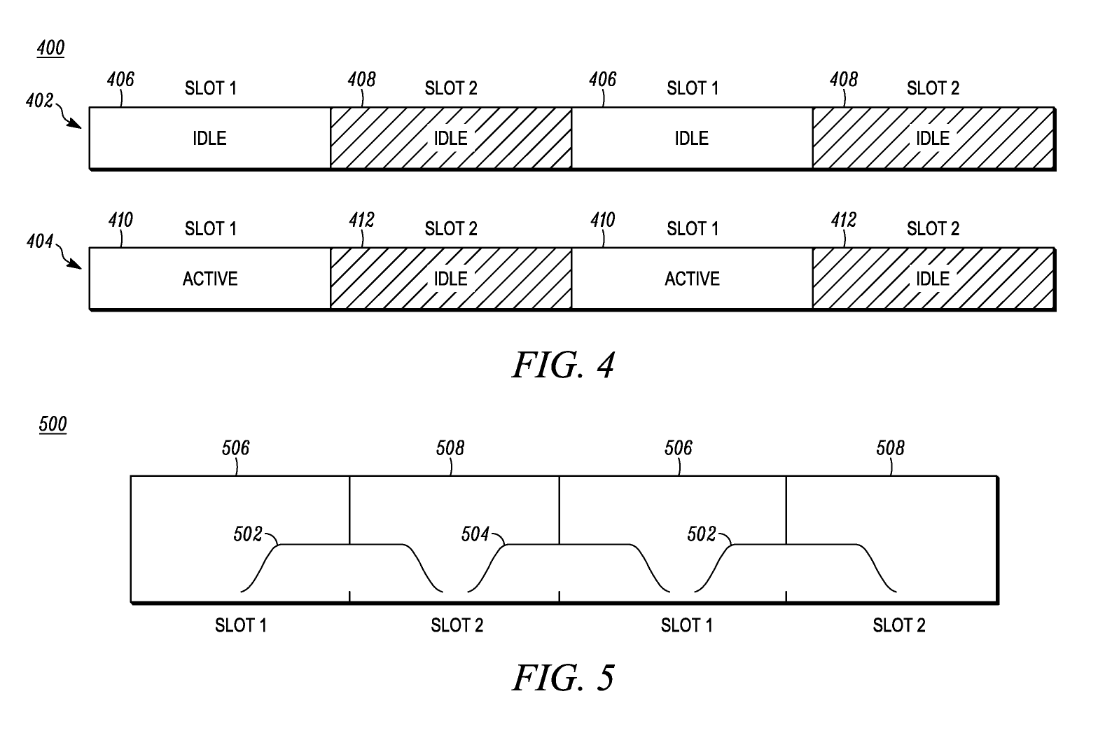

If the controller 110 determines that the delay in arrival of the first request is greater than the threshold value, as would occur for communication units 102, 106 and 108, the controller 110 assigns an available traffic channel to the request, wherein the traffic channel has delay tolerance greater than the delay in arrival of the request. The concept of the delay tolerance of a traffic channel is explained in greater detail with reference to FIGS. 4, 5, 6, and 7.

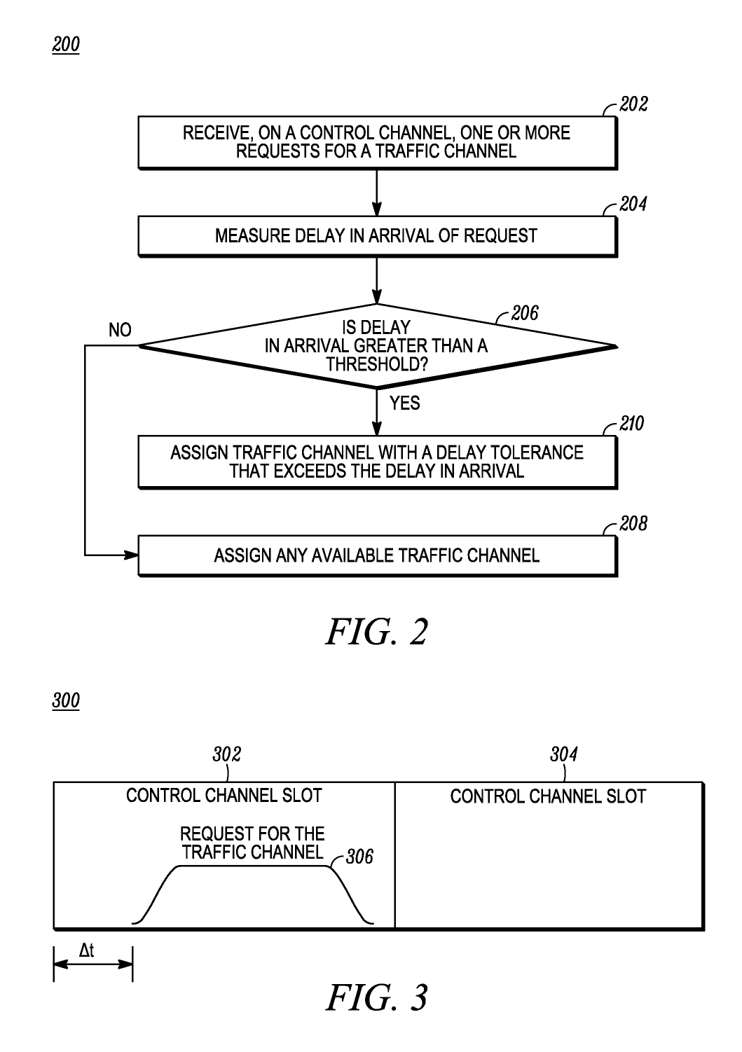

FIG. 2 illustrates a method 200 in accordance with the teachings herein for assigning a traffic channel to a wireless communication device. FIG. 2 illustrates a method 200 performed at a controller. It should be realized that method 200 includes functionality that may be performed in hardware, firmware, software, or a combination thereof and may further be performed at a single hardware device or a combination of hardware devices at multiple devices. Also, one or more steps of method 200 can be facilitated by supporting external hardware units.

In accordance with the method 200, the controller 110 receives (202) on a control channel, one or more requests for a traffic channel. Subsequently, the controller 110 measures (204) the delay in arrival of the one or more requests. Referring momentarily to FIG. 3, illustrated therein is a slot structure 300 for a control channel having a two-slot slot structure comprising a slot 302 and a slot 304. As illustrated by reference to FIG. 3, a request for a traffic channel (306) is delayed from the start of the slot 302 by a time interval At, which is deemed the delay in arrival of the message containing the request or (for the sake of brevity of description) the delay in the traffic channel request.

Referring back to FIG. 2, after determining the delay in arrival of the first request Δt, the controller determines (206) whether the delay in arrival Δt is greater than a threshold value. If the delay in arrival Δt is less than the threshold, the controller 110 assigns (208) any available traffic channel to the wireless communication device for the traffic channel request. However, if the delay in arrival Δt is greater than the threshold, the controller 110 searches for a traffic channel that has a delay tolerance greater than the delay in arrival Δt, e.g., the traffic channel either comprises at least two adjacent idle slots (idle in this context meaning that the channel has not been assigned to another communication device) to accommodate the delayed transmission within the traffic channel, or the traffic channel is an FDMA channel. The controller 110 assigns (210) the delay tolerant traffic channel to the wireless communication device. By keeping the delay within the allocated traffic channels, the controller 110 minimizes inter-slot interference. The controller 110 avoids interference between the delayed transmissions from the wireless communication device and transmissions from any other wireless communication devices by assigning the wireless communication device to a channel that tolerates longer delays.

FIGS. 4 to 7 will be used to illustrate specifics of assigning (210) a traffic channel with a delay tolerance that exceeds the delay in arrival, under a number of implementation examples. FIG. 4 illustrates a two-slot slotting structure 400. Shown are two two-slot TDMA traffic channels 402, 404. The two-slot TDMA traffic channel 402 has both its slots 406, 408 idle. Whereas, the two-slot TDMA traffic channel 404 has one slot 412 that is idle and one slot 410 that is already active, i.e., the slot 410 is already assigned to a wireless communication device.

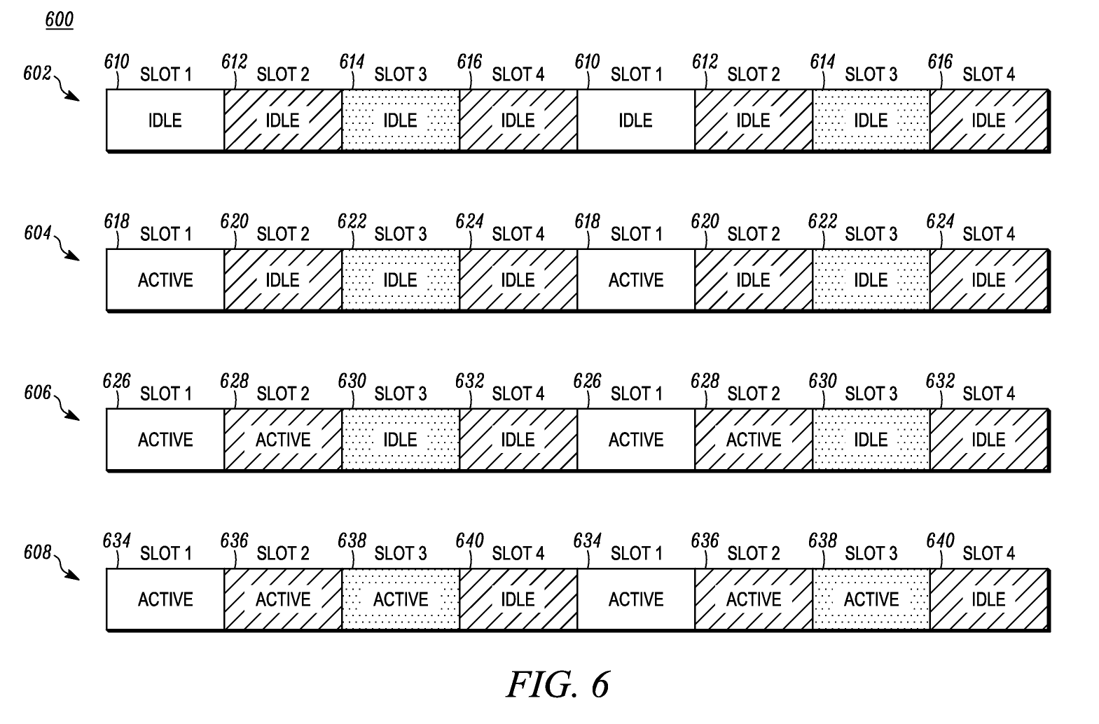

FIG. 6 illustrates a four-slot slotting structure 600. Shown are four four-slot TDMA traffic channels 602, 604, 606 and 608. The four-slot TDMA traffic channel 602 has all four of its slots 610, 612, 614 and 616 idle. Whereas, the four-slot TDMA traffic channel 604 has three slots 620, 622 and 624 that are idle and one slot 618 that is already active, i.e., the slot 618 is already assigned to a wireless communication device. Further, the four-slot TDMA traffic channel 606 has two slots 630 and 632 that are idle and two slots 626 and 628 that are already active, i.e., slots 626 and 628 are already assigned to a wireless communication device. Lastly, the four-slot TDMA traffic channel 608 has one slot 640 that is idle and three slots 634, 636 and 638 that are already active, i.e., slots 634, 636 and 638 are already assigned to a wireless communication devices.

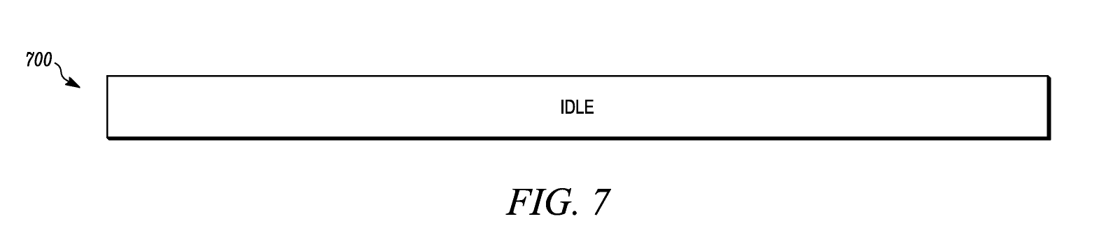

FIG. 7 illustrates a single FDMA traffic channel 700 that is idle. It can be seen that since there is no adjacent slot to encroach into, that this type of channel is not sensitive to delayed transmissions.

Referring back to FIG. 2, at 210, on determining that the delay in arrival At of the request is greater than the threshold, the controller 110 assigns the call to a traffic channel that has a sufficiently large delay tolerance. For example, the communication device could be assigned to the FDMA traffic channel 700, as illustrated in FIG. 7, if the communication device supports FDMA modulation. Alternately, the controller 110 could assign the call to a traffic channel having two adjacent idle slots, where the communication device supports TDMA modulation. For instance, the controller could assign slot 406 of the two-slot traffic channel 402 from FIG. 4, holding slot 408 from future assignments to non-delayed calls. Channel 404 could not be assigned, since it has an insufficient delay tolerance.

Alternately, the controller 110 could assign any of the following slots from FIG. 6; slot 610, holding slot 612 in reserve, slot 612 holding slot 614 in reserve, slot 614 holding slot 616 in reserve, slot 620 holding slot 622 in reserve, slot 622 holding slot 624 in reserve, or slot 630 holding slot 632 in reserve. This would prevent the delayed transmission from the first wireless communication device from interfering with the transmissions from any other wireless communication device. Thus, the interference on the traffic channel is avoided. By contrast, assigning the communication device any of the remaining slots in FIG. 6 will likely lead to undesirable inter-slot interference.

In another embodiment, the controller 110 receives a second request from a second wireless communication device for a traffic channel, while the first call is in progress. The delay of arrival of the second request is also greater than the threshold value. If, as described previously, the controller 110 assigned the first request to slot 406 on the traffic channel 402, then the controller could assign the second request to the adjacent slot 408, which was held in reserve from the assignment of the first request. The transmissions from both the wireless communication devices would not interfere with each other, because the transmissions for both the requests are delayed (explained in greater detail while describing FIG. 5). Therefore, the interference on the channel is minimized, and the traffic channel is utilized more efficiently.

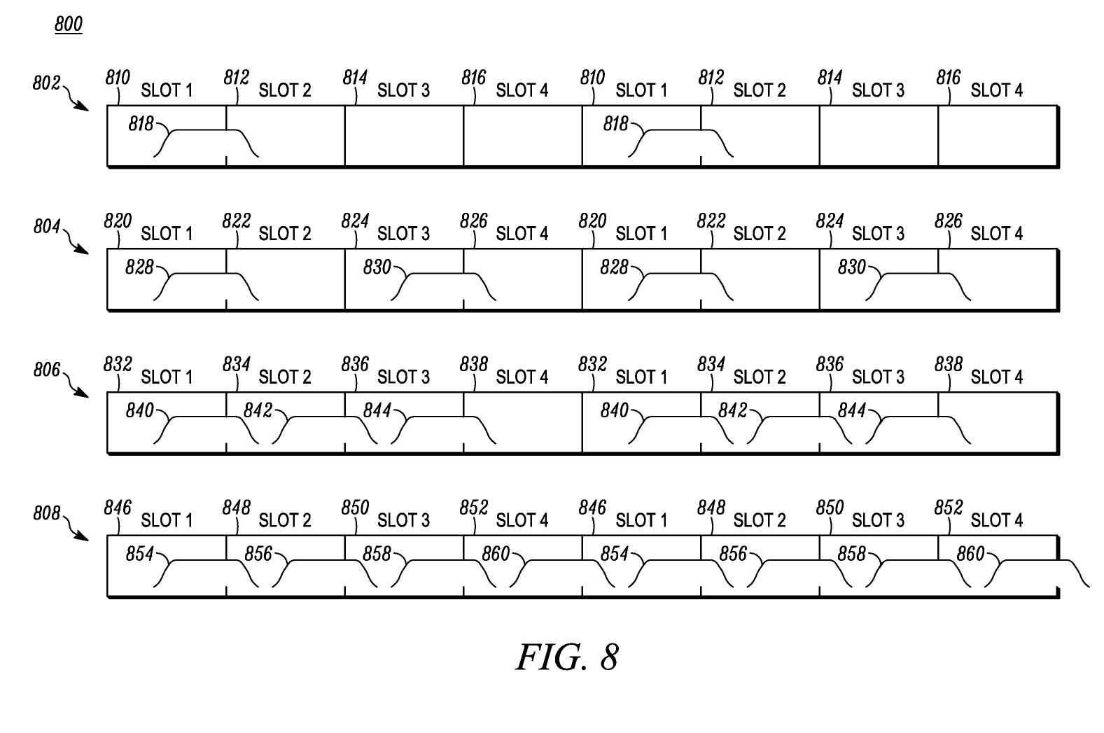

FIG. 5 illustrates the timing of delayed transmissions in a two-slot TDMA traffic channel 500. The traffic channel 500 includes slots 506, 508 assigned to two different requests, wherein the delay in arrival for both the requests were greater than the threshold value. A transmission 502 illustrates the transmissions by a first wireless communication device, and transmission 504 illustrates transmissions by a second wireless communication device. The transmissions 502 and 504 do not interfere with each other, because both the transmissions are delayed by a time that is greater than the threshold value. Therefore, both the first and the second wireless communication devices can use the channel simultaneously without interfering with each others transmissions, as illustrated by FIG. 5. The teachings herein can also be applied to a four-slot TDMA traffic channel, described in greater detail with reference to FIG. 8.

Turning to FIG. 8, in one embodiment, on determining that the delay in arrival of a first request Δt, from a first wireless communication device, is greater than the threshold (FIG. 2, block 206), the controller 110 from FIG. 1 assigns slot 810 and reserves slot 812 for voice traffic 818 on the traffic channel 802 for the first wireless communication device. Therefore, even if the transmissions from the first wireless communication device are delayed; the transmission would not interfere with the transmissions from any other wireless communication device.

If a second request arrives that also has a delay in arrival greater than the threshold, the controller 110 from FIG. 1 assigns slot 814 and reserves slot 816 of traffic channel 802 for the new request. The result of these two assignments is shown in traffic channel 804, where in this case, it can be seen that the voice traffic from the first request 828 is located in slot 820, with slot 822 still in reserve and the voice traffic from the second request 830 located in slot 824 with slot 826 in reserve. Thus, the interference for the traffic channel is minimized, and the traffic channel is utilized more efficiently.

Further upon receiving a third request that also has a delay in arrival greater than the threshold, the controller 110 from FIG. 1 can assign either reserved slot 822 or reserved slot 826 for the new voice traffic on traffic channel 804. The result of the case where slot 822 is assigned is shown in traffic channel 806, where in this case, it can be seen that the voice traffic from the first request 840 is located in slot 832, the voice traffic from the second request 844 is located in slot 836 with slot 838 in reserve, and the voice traffic from the third request 842 is located in slot 834. Thus, the interference for the traffic channel is minimized, and the traffic channel is utilized more efficiently.

If a fourth request arrives that also has a delay in arrival greater than the threshold, the controller 110 from FIG. 1 can assign the reserved slot 838 for the new voice traffic on traffic channel 806. The result of the case where slot 838 is assigned is shown in traffic channel 808. In this case it can be seen that the voice traffic from the first request 854 is located in slot 846; the voice traffic from the second request 858 is located in slot 850; the voice traffic from the third request 856 is located in slot 848; and the voice traffic from the fourth request 860 is located in slot 852. Thus, the interference for the traffic channel is minimized, and the traffic channel is utilized more efficiently.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for assigning a traffic channel in a wireless communication system, the method comprising:
receiving on a control channel a first message comprising a request for a traffic channel having a traffic channel structure;
determining a delay in arrival of the first message;
comparing the delay in arrival to a threshold value for the traffic channel structure; and
when the delay in arrival exceeds the threshold value, assigning an available traffic channel in response to the request, wherein the traffic channel has a delay tolerance that exceeds the delay in arrival.

2. The method of claim 1, wherein the control channel and the assigned traffic channel each comprises a Time Division Multiple Access (TDMA) slot structure.

3. The method of claim 2, wherein the traffic channel structure comprises a TDMA two-slot slot structure.

4. The method of claim 2, wherein the traffic channel structure comprises a TDMA four-slot slot structure.

5. The method of claim 4, wherein a first traffic comprising a first set of two adjacent idle slots is assigned to the request, the method further comprising:
receiving a second message comprising a second request for a traffic channel, the second message having a delay in arrival that is greater than the threshold value; and
assigning, in response to the second request, a second traffic channel comprising a second set of two adjacent idle slots.

6. The method of claim 5 further comprising:
receiving a third message comprising a third request for a traffic channel, the third message having a delay in arrival that is greater than the threshold value; and
assigning, in response to the third request, the first slot of the two adjacent idle slots in the first traffic channel.

7. The method of claim 6 further comprising:
receiving a fourth message comprising a fourth request for a traffic channel, the fourth message having a delay in arrival that is greater than the threshold value; and
assigning, in response to the fourth request, the first slot of the two adjacent idle slots in the second traffic channel.

8. The method of claim 2, wherein the assigned traffic channel comprises at least two adjacent idle slots.

9. The method of claim 8, wherein the threshold value is equal to a guard time for a single slot of the assigned traffic channel.

10. The method of claim 8 further comprising:
receiving a second message comprising a second request for a traffic channel having a delay in arrival that is greater than the threshold value; and
assigning, in response to the second request, a second traffic channel comprising the first slot of the two adjacent idle slots.

11. The method of claim 2, wherein determining the delay in arrival comprises measuring an offset of the first message with respect to the slot structure of the control channel.

12. The method of claim 1, wherein the assigned traffic channel comprises a Frequency Division Multiple Access (FDMA) channel.

13. A device for assigning a traffic channel in a wireless communication system, the apparatus comprising:
a transceiver for receiving on a control channel a first message comprising a request for a traffic channel having a traffic channel structure;
a processor coupled to the transceiver, the processor for determining a delay in arrival of the first message;
comparing the delay in arrival to a threshold value for the traffic channel structure; and
when the delay in arrival exceeds the threshold value, assigning an available traffic channel in response to the request, wherein the traffic channel has a delay tolerance that exceeds the delay in arrival.
